(19) United States
(12) Patent Application Publication
(10) Pub. No.: US 2009/0224904 A1
(43) Pub. Date: Sep. 10, 2009

(54) Vehicle Occupant Safety Device

(76) Inventor: Eugene Jarrett, Winter Park, FL (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/042,520

(22) Filed: Mar. 5, 2008

(51) Int. Cl. B60Q 1/26

(52) U.S. Cl. 340/468; 340/425.5

(57) ABSTRACT

Disclosed is a safety device for ensuring safety of occupants in a vehicle. The safety device includes a temperature sensor and a strap. The temperature sensor is capable of sensing an interior temperature of the vehicle. The strap is attached to a seat belt of the vehicle. The strap is operatively coupled to the temperature sensor and adapted to activate the temperature sensor upon a pulling action of the seat belt by the occupant of the vehicle. The temperature sensor is capable of activating a warning signal upon occurrence of a predetermined limit of the interior temperature of the vehicle.

### FIELD OF THE INVENTION

The present invention relates generally to safety devices, and, more particularly, to a safety device for ensuring safety of an occupant in a vehicle.

### BACKGROUND OF THE INVENTION

Vehicles are typically equipped with safety devices such as seat belts and air bags. In case of accidents, the seat belts serve to restrain movement of vehicle occupants in their seat, thereby preventing injury to the vehicle occupants wearing the seat belt. The seat belts may also be pulled across the infant seat for restraining movement of an infant while the vehicle is in a moving condition. Accidentally or otherwise, parents may occasionally leave their children in the vehicle and proceed to perform a chore such as buying daily groceries. In such a case, in addition to locking the vehicle, the parents may ensure that the kids are wearing their seat belt for safety purposes.

Leaving occupants locked in a vehicle may expose the occupants to conditions such as a rise in temperature in the closed vehicle. The temperature increases rapidly inside the closed vehicle, and, more particularly when exposed to outside heat. In summer, the temperature inside the closed vehicle may go beyond the normal ambient temperature within a short period of a time. High temperature hinders an ability of an occupant of the vehicle to regulate his/her body temperature. The problem may get worse if the occupant is a child and lacking a caretaker. Every year, a large number of children either get injured or lose their lives due to accidental incidents of leaving the children inside the closed vehicle with rising temperature.

Accordingly, there exists a need for a safety device for ensuring safety of occupants in a vehicle on account of rise in temperature in the vehicle. Further, there exists a need for a safety device capable of alerting bystanders of potential threat to a child left behind in the vehicle. Also, there exists a need for a safety device for ensuring safety of vehicle occupants to be easily integrated into an existing safety mechanism in the vehicle.

### SUMMARY OF THE INVENTION

In view of the foregoing disadvantages inherent in the prior art, the general purpose of the present invention is to provide a safety device configured to include all the advantages of the prior art, and to overcome the drawbacks inherent therein.

Therefore, an object of the present invention is to provide a safety device capable of ensuring safety of an occupant in a vehicle, on account of rise in temperature in the vehicle.

Another object of the present invention is to provide a safety device, which is capable of generating a warning signal on occurrence of a predetermined limit of an interior temperature of a vehicle and a presence of an occupant in the vehicle.

Yet another object of the present invention is to provide a safety device to be easily integrated into an existing safety mechanism in the vehicle.

Therefore, the present invention provides a safety device for ensuring safety of an occupant in a vehicle. The safety device includes a temperature sensor and a strap. The temperature sensor is capable of sensing an interior temperature of the vehicle. The strap is attached to a seat belt of the vehicle. The strap is operatively coupled to the temperature sensor and adapted to activate the temperature sensor upon a pulling action of the seat belt by the occupant of the vehicle. The temperature sensor is capable of activating a warning signal upon occurrence of a predetermined limit of the interior temperature of the vehicle.

In one aspect of the present invention, the warning signal may include activation of at least one of rear wheel lights, front wheel lights, emergency flasher lights or a sound alarm for alerting bystanders of potential threat of rising temperature to an occupant, such as an infant, in the vehicle.

In another aspect of the present invention, the safety device may easily be coupled to existing safety mechanism, such as a seat-belt, in a vehicle precluding any need for modification to the existing safety mechanism.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a perspective view of a vehicle occupant area with a safety device installed for ensuring safety of occupants in the vehicle, in accordance with an embodiment of the present invention; and

FIG. 2 is a side view of the vehicle occupant area of FIG. 1 for depicting an exemplary wiring arrangement for activation of a warning signal by the safety device, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular safety device, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

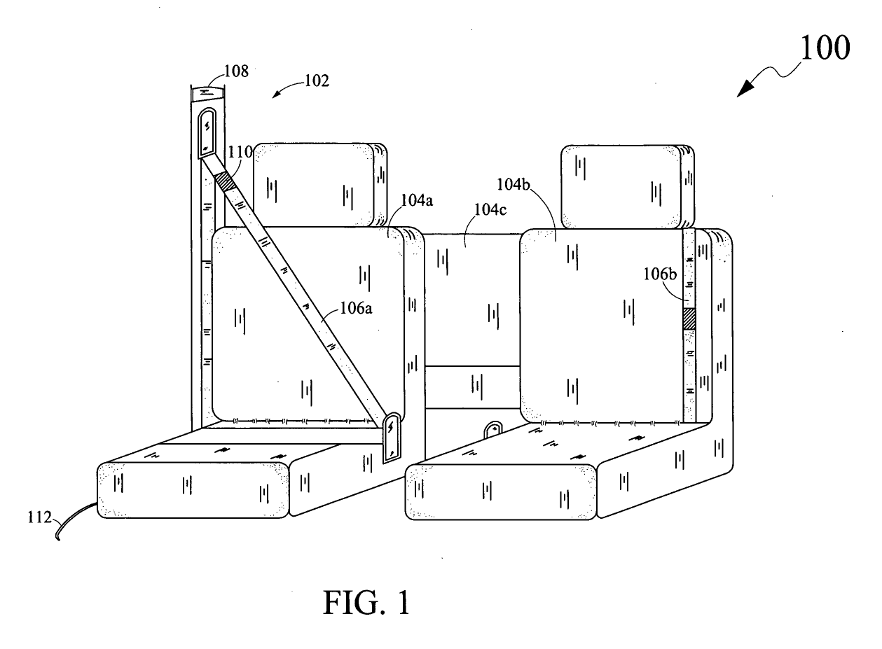

FIG. 1 is a perspective view of a vehicle occupant area 100 with a safety device 102 installed for ensuring safety of occupants (not shown) in the vehicle (not shown), in accordance with an embodiment of the present invention. The vehicle occupant area 100 includes a first front seat 104a, a second front seat 104b and a rear seat 104c. The first front seat 104a, the second front seat 104b and the rear seat 104c will hereinafter be commonly referred to as seats 104. The first front seat 104a is provided with a seat belt 106a, and, the second front seat 104b is provided with a seat belt 106b. It will be evident to those skilled in the art that each of the seats 104 is provided with a seat-belt for ensuring safety of the occupants, seated on each of the seats, in case of accidents.

The safety device 102 includes a temperature sensor 108 and a strap 110. The temperature sensor 108 is capable of sensing temperature in the vehicle occupant area 100, hereinafter referred to as an interior temperature of the vehicle. The temperature sensor 108 is mounted in an interior position in the vehicle for precluding direct contact of the temperature sensor 108 with sunlight. The strap 110 is attached to the seat belt. In one embodiment of the present invention, the strap 110 is attached proximate to a top portion of the seat belt 106a. In one embodiment of the present invention, the strap 110 is configured of a hook and loop fastening material. The hook and loop fastening material may be a Velcro hook and loop fastening material.

The strap 110 is operatively coupled to the temperature sensor 108 and is adapted to activate the temperature sensor 108 upon a pulling action of the seat belt 106a. In one embodiment of the present invention, a coupling means such as a spring loaded contact is provided to operatively couple the strap 110 with the temperature sensor 108. The pulling action of the seat belt 106a activates the temperature sensor 108. In another embodiment of the present invention, a transducer is provided to operatively couple the strap 110 with the temperature sensor 108. The transducer is capable of converting a pulled state or a stretched state of the seat belt 106a, i.e. displacement, of the strap 110 into an electrical signal for activating the temperature sensor 108. On activation, the temperature sensor 108 starts sensing the interior temperature of the vehicle.

The temperature sensor 108 generates a warning signal upon occurrence of a predetermined limit of the interior temperature of the vehicle. In one embodiment of the present invention, the predetermined limit of the interior temperature of the vehicle is a predefined ambient temperature. The predefined ambient temperature may be set based on a weather forecast or an existing weather condition decided by a vehicle owner, a driver of the vehicle, an occupant in the vehicle and the like. On occurrence of the predetermined limit of the interior temperature of the vehicle, the temperature sensor 108 activates a warning signal. The warning signal may be an activation of front flashing lights, rear flashing lights, an emergency flasher light or a sound alarm of the vehicle for alerting vehicle occupants of rise in temperature in the vehicle. In case of infants, left behind in the vehicle, restrained by wearing the seat belt 106a, the warning signal may alert bystanders of the potential threat to an infant by the rise in temperature in the interior of the vehicle.

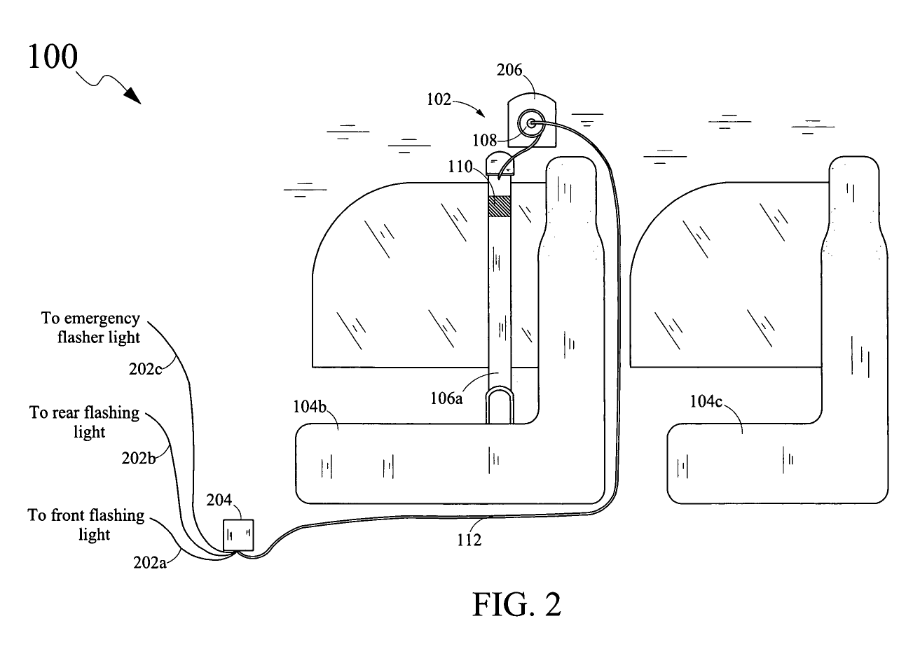

It will be evident to those skilled in the art that various combinations of sound alarms or activation of the vehicle lights may be used for alerting occupants or bystanders of potential threat to the occupants on account of rise in the interior temperature of the vehicle. The warning signal may only be disengaged when the occupant is moved out of the vehicle or the interior temperature of the vehicle drops below the predetermined limit. A wiring arrangement including wires, such as a ground wire 112, may be provided for connecting the temperature sensor 108 to one or more vehicle lights for activating the warning signal. An exemplary wiring arrangement is explained in conjunction with FIG. 2.

FIG. 2 is a side view depicting an exemplary wiring arrangement for activation of a warning signal by the safety device 102 of FIG. 1, in accordance with an embodiment of the present invention. As explained in conjunction with FIG. 1, the warning signal may be activated in the form of flashing lights such as activating rear flashing lights, front flashing lights, emergency flasher lights or by activation of a sound alarm. The wiring arrangement includes the ground wire 112 and auxiliary wires such as an auxiliary wire 202a, an auxiliary wire 202b and an auxiliary wire 202c. The ground wire 112 extends from the temperature sensor 108 to an electrical connector unit 204 installed under a vehicle's dash board (not shown). The electrical connector unit 204 may serve as a junction for connecting the temperature sensor 108 to one or more vehicle lights such as the front flashing lights, the rear flashing lights or the emergency flasher light by means of the auxiliary wires such as the auxiliary wire 202a, the auxiliary wire 202b and the auxiliary wire 202c respectively.

The temperature sensor 108 is housed in a casing 206 with a tip of the temperature sensor 108 extending out of an opening (not shown) in the casing 206. In one embodiment of the present invention, the casing is 3 inches wide and 5 inches in height. The tip of the temperature sensor 108 may be capable of contacting to the spring loaded contact coupled to the seat belt 106a. As explained in conjunction with FIG. 1, the seat belt 106a, when pulled, activates the temperature sensor 108 by means of the spring loaded contact. The ground wire 112 may be configured to make ground contact with the temperature sensor 108 to relay a current to the electrical connector unit 204. The electrical connector unit 204 may then relay the current to the flashing lights for activating the warning signal.

As explained in conjunction with FIG. 1, a safety device, such as the safety device 102, may be used for ensuring safety of occupants in a vehicle on account of rise in the interior temperature of the vehicle. On occurrence of the predetermined limit of interior temperature and presence of occupants in a vehicle (determined by a pulled state of seat belt such as seat belt 106a), a temperature sensor such as the temperature sensor 108 may activate warning signal for alerting occupants or bystanders of danger posed by rise in the interior temperature of the vehicle. The safety device may especially be beneficial to thwarting danger to infants left behind in the vehicle by parents or caretakers. The warning signal may alert the parents, caretakers or bystanders of the potential threat to the infant by rise in temperature in the interior of the vehicle. The infant may then be rescued by alerting the owner of the vehicle. Further, the safety device is configured to be easily integrated into existing safety mechanism in the vehicle such as a seat belt precluding any modification to the existing safety mechanism.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A safety device for ensuring safety of an occupant in a vehicle, the safety device comprising:
a temperature sensor capable of sensing an interior temperature of the vehicle; and
a strap attached to a seat belt of the vehicle, the strap operatively coupled to the temperature sensor and adapted to activate the temperature sensor upon a pulling action of the seat belt,
wherein the temperature sensor is capable of activating a warning signal upon occurrence of a predetermined limit of the interior temperature of the vehicle.

2. The safety device of claim 1, wherein the activation of the warning signal comprises an activation of rear flashing lights of the vehicle.

3. The safety device of claim 1, wherein the activation of the warning signal comprises an activation of front flashing lights of the vehicle.

4. The safety device of claim 1, wherein the activation of the warning signal comprises an activation of an emergency flasher light of the vehicle.

5. The safety device of claim 1, wherein the activation of the warning signal comprises an activation of a sound alarm of the vehicle.

6. The safety device of claim 1, further comprising a coupling mechanism for operatively coupling the strap to the temperature sensor.

7. The safety device of claim 6, wherein the coupling mechanism is a spring loaded contact.

8. The safety device of claim 1, wherein the predetermined limit of the interior temperature of the vehicle is a predefined ambient temperature.

9. The safety device of claim 1, wherein the temperature sensor is mounted in an interior position in the vehicle for precluding direct contact of the temperature sensor with sunlight.

10. The safety device of claim 1, wherein the strap is attached proximate to a top portion of the seat belt.
